(19) United States
(12) Patent Application Publication
(10) Pub. No.: US 2006/0076386 A1
(43) Pub. Date: Apr. 13, 2006

(54) End cap assembly for a nailer

(75) Inventors: Laing-Chi Hung, Taichung City (TW); Lai Chun Chih, Taichung City (TW)

Correspondence Address: CHARLES E. BAXLEY, ESQ., 90 JOHN STREET, THIRD FLOOR, NEW YORK, NY, 10038, US

(73) Assignee: Basso Indusry Corp.

(21) Appl. No.: 10/960,316

(22) Filed: Oct. 7, 2004

(51) Int. Cl. B25C 1/04

(52) U.S. Cl. 227/130

(57) ABSTRACT

The present invention relates to an end cap assembly for a nailer whose bush ring is disposed between the end cap and the moveable member, at the inner periphery and the outer periphery of the bush ring is formed an annular protrusion, respectively. At the bottom of the bush ring are provided a bush block and a plurality of backing ribs, around the periphery of the bush block are formed a plurality of spiracles. The bush ring has multiple functions and is able to take the place of the inner seal ring, the outer seal ring, the buffering cushion and the like components of the conventional nailer. Thus, the structure of the end cap is simplified. The bush ring is formed by integral plastic ejection, thereby, the production cost and the concurrent assembly time are saved.

### BACKGROUND OF THE INVENTION

1. Field of the Invention

The present invention relates to a nailer, and more particularly to an end cap assembly of a nialer, which is simply constructed and provided with a bush ring capable of taking the place of the inner seal ring, the outer seal ring, the buffering cushion and the like components of the conventional nailer.

2. Description of the Prior Arts

A conventional nailer is normally provided in its end cap with many complicated components in order to make the end cap have multi-functions, such as: the buffering, the air-exhausting and the air-tightening functions. Thus, consequent problems will be caused as follows:

First, to have the buffering, the air-exhausting and the air-tightening functions, different necessary components must be disposed in the rear end cap, thus increasing the assembly time.

Second, the respective components in the end cap of the nailer are manufactured independently of each other, thereby, it is difficult to control the production cost.

The present invention has arisen to mitigate and/or obviate the afore-described disadvantages.

### SUMMARY OF THE INVENTION

The primary objective of the present invention is to provide a simply constructed end cap assembly for a nailer. A bush ring is disposed between the end cap and the moveable member, around the inner periphery and the outer periphery of the bush ring is formed an annular protrusion, respectively. At the bottom of the bush ring are provided a bush block and a plurality of backing ribs, around the periphery of the bush block are formed a plurality of spiracles. The bush ring has multiple functions, such as, the buffering, the air-exhausting and the air-tightening functions, and is able to take the place of the inner seal ring, the outer seal ring, the buffering cushion and the like components of the conventional nailer. Thus, the structure of the end cap assembly is simplified.

The secondary objective of the present invention is to provide a cost-saving end cap assembly for a nailer, wherein the bush ring is formed by integral plastic ejection. Thus, the production cost and the concurrent assembly time of the end cap assembly are saved.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of an end cap assembly in accordance with the present invention;

FIG. 2 is another perspective view of the end cap assembly in accordance with the present invention;

FIG. 3 is a cross sectional view of a bush ring in accordance with the present invention;

FIG. 4 is an exploded view of the end cap assembly in accordance with the present invention;

FIG. 5 is an assembly cross sectional view of the end cap assembly in accordance with the present invention.

### DETAILED DESCRIPTION OF THE PREFERRED EMBODIMENT

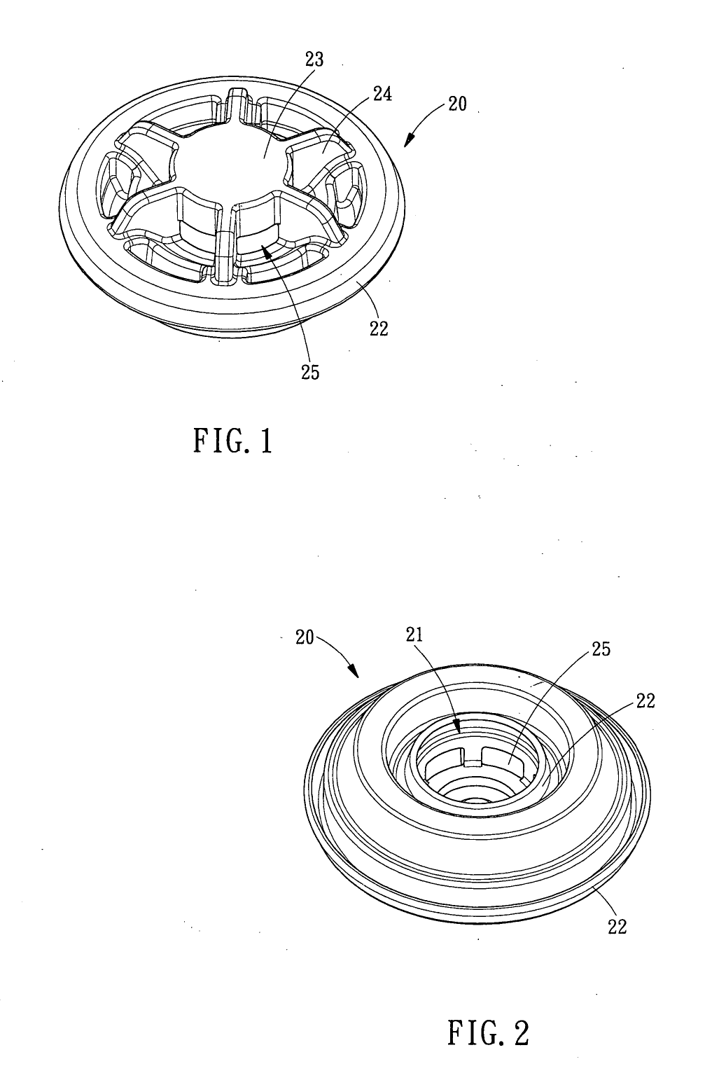

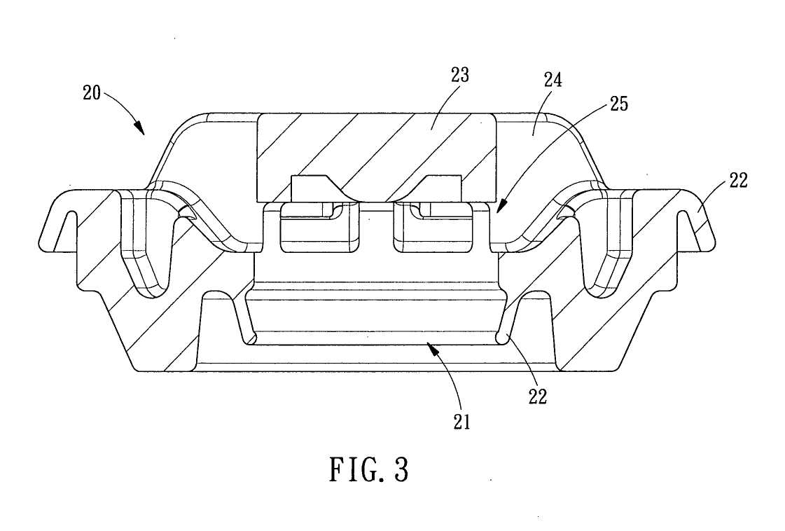

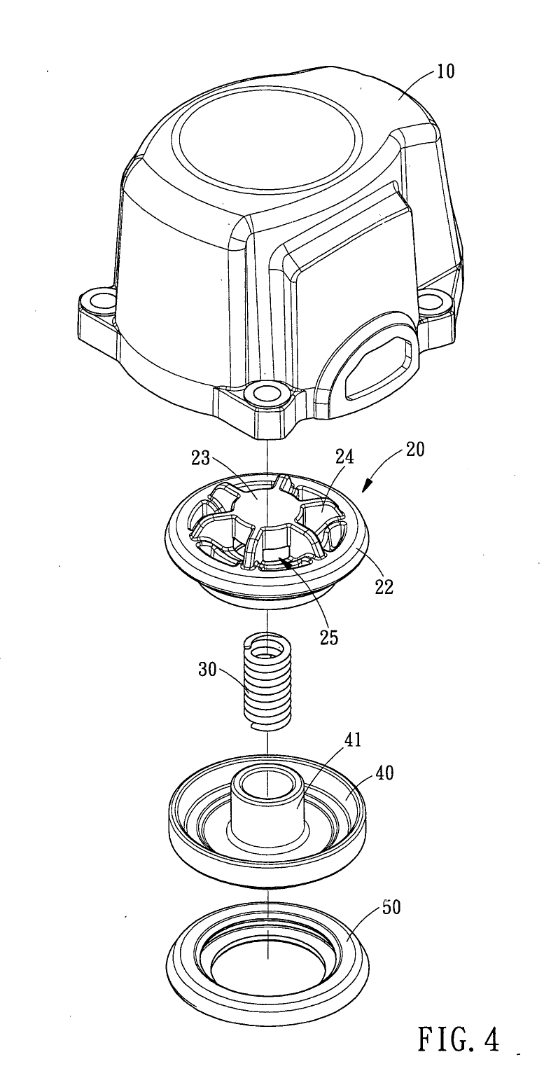

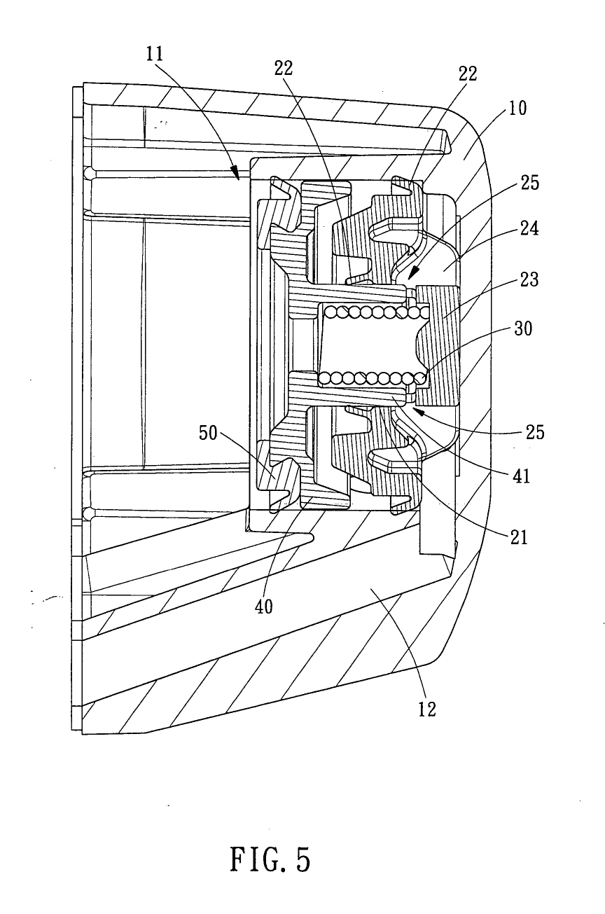

Referring to FIGS. 1-5, an end cap assembly in accordance with the present invention is shown and generally comprised of: an end cap 10, a bush ring 20, a spring 30, a movable member 40 and a choke ring 50 (or an O-shaped choke ring). The bush ring 20, the spring 30, the movable member 40 and the choke ring 50 are sequentially disposed in the end cap 10.

The end cap 10 employs a space 11 to receive the bush ring 20, the spring 30, the movable member 40 and the choke ring 50. In the bottom edge of the end cap 10 is defined an exhaust passage 12.

The bush ring 20 is integrally formed by plastic ejection and formed in the center thereof with a receiving hole 21. About the periphery of the bush ring 20 and the receiving hole 21 are formed an annular protrusion 22 which is made of elastic plastic and slightly protrudes outward. At the bottom center of the bush ring 20 is provided a bush block 23 corresponding to the receiving hole 21, and a plurality of backing ribs 24 are formed around the bush block 23. A plurality of spiracles 25 are formed around the bush block 23 and connected to the receiving hole 21 and the exhaust passage 12 at the bottom edge of the 10.

The spring 30 is installed in the receiving hole 21 of the bush ring 20.

The movable member 40 is engaged with the choke ring 50, and the choke ring 50 air-tightly seals the movable member 40. A tubular portion 41 of the movable member 40 is inserted in the receiving hole 21 of the bush ring 20 and the spring 30 is biased between the bush block 23 of the bush ring 20 and the movable member, so that the movable member 40 is moveably relative to the bush ring 20.

In operation, the movable member 40 will reciprocate in the end cap 10 and will strike against the bush ring 20 repeatedly (since the movable member 40 will reciprocate along with the piston of the nailer), and the tubular portion 41 will cooperate with the spring 30 to transmit the striking force to the bush ring 20. At this moment, the plastic made bush ring 20 can absorb the striking force effectively, while the annular protrusion 22 around the periphery of the bush ring 20 and the receiving hole 21 can ensure the air tightness. Meanwhile, the bush block 23 at the bottom center of the bush ring 20 will cooperate with the backing ribs 24 to absorb the striking force from the moveable member 40. Thus, the bush ring 20 is able to take the place of the inner seal ring, the outer seal ring, the buffering cushion, and etc. As a result, the structure is simplified.

It is to be noted that the spiracles 25 are formed around the bush block 23 and connected to the receiving hole 21 and the exhaust passage 12 at the bottom edge of the 10, thus providing a good effect of air exhaust.

Another function of the present invention is that the bush ring 20 is integrally formed by plastic ejection, so that not only the bush ring 20 is able to absorb the striking force more quickly, but also the technology of integral plastic ejection can save the production cost and reduce the concurrent assembly time.

While we have shown and described various embodiments in accordance with the present invention, it should be clear to those skilled in the art that further embodiments may be made without departing from the scope of the present invention.

What is claimed is:

1. An end cap assembly for a nailer comprising:
an end cap, a bush ring, a spring, a moveable member and a choke ring, the bushing, the spring, the moveable member and the choke ring sequentially disposed in the end cap, and an exhaust passage formed in the end cap, wherein:
the bush ring is integrally formed by plastic ejection, the bush ring is further integrally formed with annular protrusion for ensuring air-tightness, at a bottom center of the bush ring is provided a bush block corresponding to a receiving hole of the bush ring, and a plurality of spiracles are formed around the bush block and connected to the exhaust passage.

2. The end cap assembly for a nailer as claimed in claim 1, wherein:
the end cap employs a space to receive the bush ring, the spring, the movable member and the choke ring, at a bottom edge of the end cap is defined the exhaust passage;
the bush ring formed at its center thereof with the receiving hole, about a periphery of the bush ring and the receiving hole the formed the annular protrusion which is made of elastic plastic and slightly protrudes outward, a plurality of backing ribs are formed around the bush block, the plurality of spiracles are formed around the bush block and connected to the receiving hole of the bush ring;
the spring is installed in the receiving hole of the bush ring;
the movable member is engaged with the choke ring, and the choke ring air-tightly seals the movable member, the movable member reciprocates in the end cap along with a piston of a nailer, a tubular portion of the movable member is inserted in the receiving hole of the bush ring by cooperating with the spring, the movable member strikes reciprocally against the bush ring.
